(19) United States
(12) Patent Application Publication
(10) Pub. No.: US 2012/0271763 A1
(43) Pub. Date: Oct. 25, 2012

(54) METHOD AND SYSTEM FOR MOBILE REMITTANCE

(75) Inventors: Alvin David Toms, Hong Kong (JP); Stephen Kai Chiu Sui, Singapore (SG)

(73) Assignee: NEURAL TECHNOLOGIES LIMITED, Overland Park, KS (US)

(21) Appl. No.: 13/452,309

(22) Filed: Apr. 20, 2012

Related U.S. Application Data
(60) Provisional application No. 61/477,400, filed on Apr. 20, 2011.

(51) Int. Cl. G06Q 40/00; G06Q 20/36; G06Q 20/32

(52) U.S. Cl. 705/41; 705/44

(57) ABSTRACT

Methods and systems of mobile remittance that are network-agnostic and that allow transfer of funds across any network, regardless of whether these networks have funds transfer agreements with each other. In accordance with aspects of the present invention, the methods and systems of mobile remittance transactions are easy to use and secure, and ensure that the mobile remittance reaches the intended recipient, regardless of whether the recipient is in an urban or rural area.

This application claims priority from U.S. Provisional Application No. 61/477,400, filed on Apr. 20, 2011, titled “Method and System for Mobile Remittance,” which is incorporated herein by reference in its entirety.

### BACKGROUND OF THE INVENTION

1. Field of Invention

Aspects of the present invention relate to methods and systems for providing a remittance from one mobile device to another. More particularly, aspects of the current invention related to methods and systems for transferring funds from one mobile device to another when the mobile devices do not belong to the same network.

2. Description of Related Art

While mobile currency remittance and/or other mobile remittance of monetary/non-monetary value (e.g., credit) via Short Message Services (SMSs) are known in the art, there are currently several problems with the existing methods of mobile remittance. One problem is that such transfers depend on the originating user's mobile carrier or network and which other carriers have agreements to transfer funds, either nationally or internationally, with the originating carrier. That is, currently, mobile remittance may be achieved only among users of the same carrier or among users of carriers that have agreements with the originating carrier. Another problem in the art today relates to the security of the mobile transaction, as many such remittance transactions are inherently insecure. Further, the current methods for mobile remittance are cumbersome and involve multiple steps, including organizing the sale of and purchasing cash cards or other prepaid cards, signing up authorized agents (such as banks or merchants, for example), and ensuring that the agents have access to funds to provide as part of the remittance transaction, among other steps. In addition, the current methods and systems for mobile remittance are difficult to use, especially in rural areas, where banks/Automated Teller Machines (ATMs) may not be as prevalent as in urban areas, and there is a risk that the mobile remittance may not reach the intended recipient.

There is a need in the art for methods and systems of mobile remittance that are network-agnostic and that allow transfer of funds across any network, regardless of whether these networks have or do not have direct funds transfer agreements between the initiating and receiving networks. There is another need in the art for mobile remittance transactions that are easy to use and secure, and that ensure that the mobile remittance reaches the intended recipient, regardless of whether the recipient is in an urban or rural area.

### SUMMARY

In light of the above described problems and unmet needs, aspects of the present invention solve the above-identified needs, as well as others, by providing methods and systems of mobile remittance that are network-agnostic and that allow transfer of funds across any network, regardless of whether these networks have or do not have funds transfer agreements among each other. In addition, aspects of the present invention provide methods and systems for mobile remittance transactions that are easy to use and secure, and that ensure that the mobile remittance reaches the intended recipient, regardless of whether the recipient is in an urban or rural area.

Additional advantages and novel features of the invention will be set forth in part in the description that follows, and in part will become more apparent to those skilled in the art upon examination of the following or upon learning by practice of the invention.

### BRIEF DESCRIPTION OF THE DRAWINGS

Various example aspects of the systems and methods will be described in detail, with reference to the following figures, wherein:

FIGS. 1A-H illustrate various implementations in accordance with aspects of the present invention;

FIGS. 2A-E illustrate various implementations in accordance with aspects of the present invention;

FIGS. 3A-C illustrate various implementations in accordance with aspects of the present invention;

FIG. 4 presents an example system diagram of various hardware components and other features, for use in accordance with aspects of the present invention; and

FIG. 5 is a block diagram of various example system components, for use in accordance with aspects of the present invention.

### DETAILED DESCRIPTION

These and other features and advantages of this invention are described in, or are apparent from, the following detailed description of various example aspects.

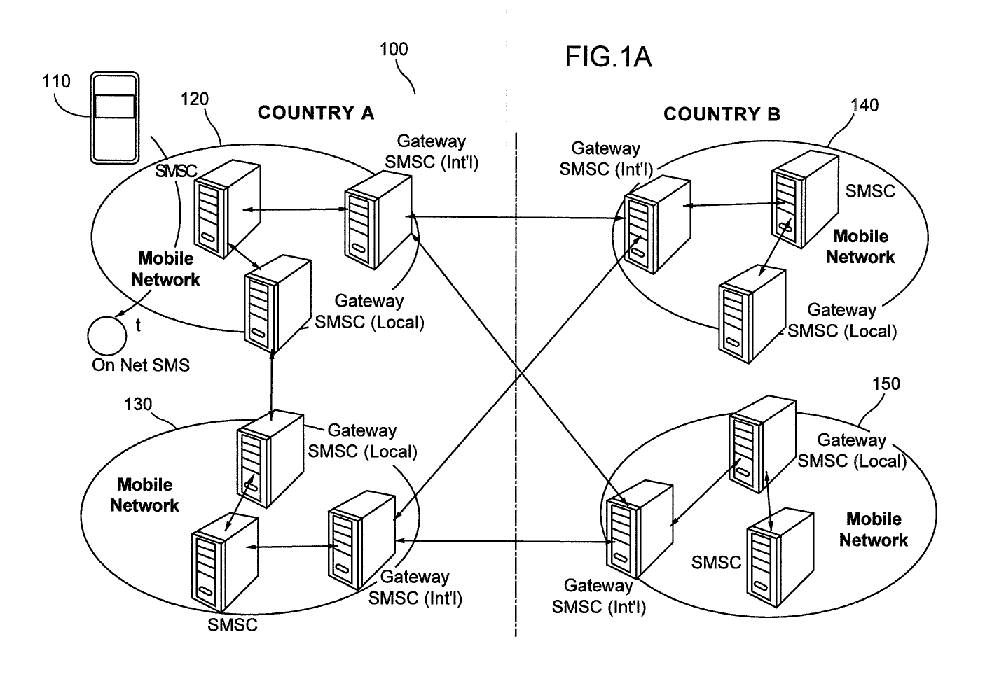

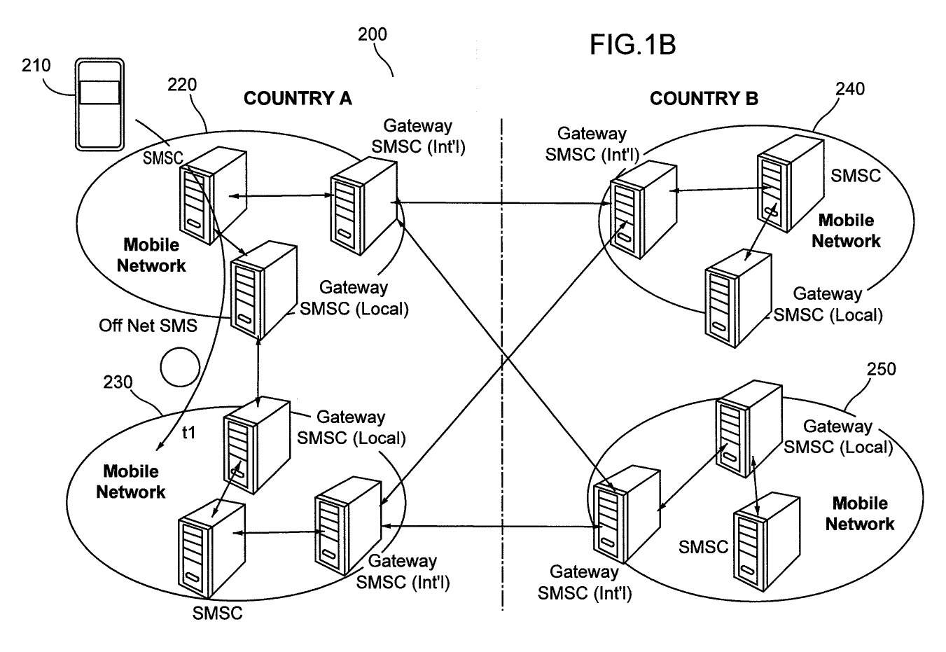

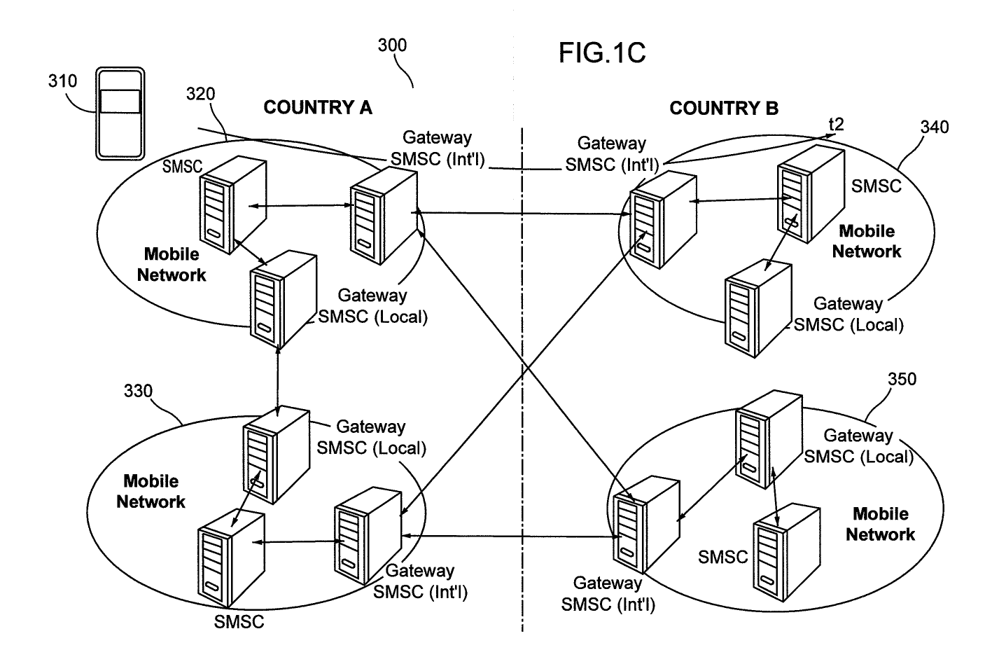

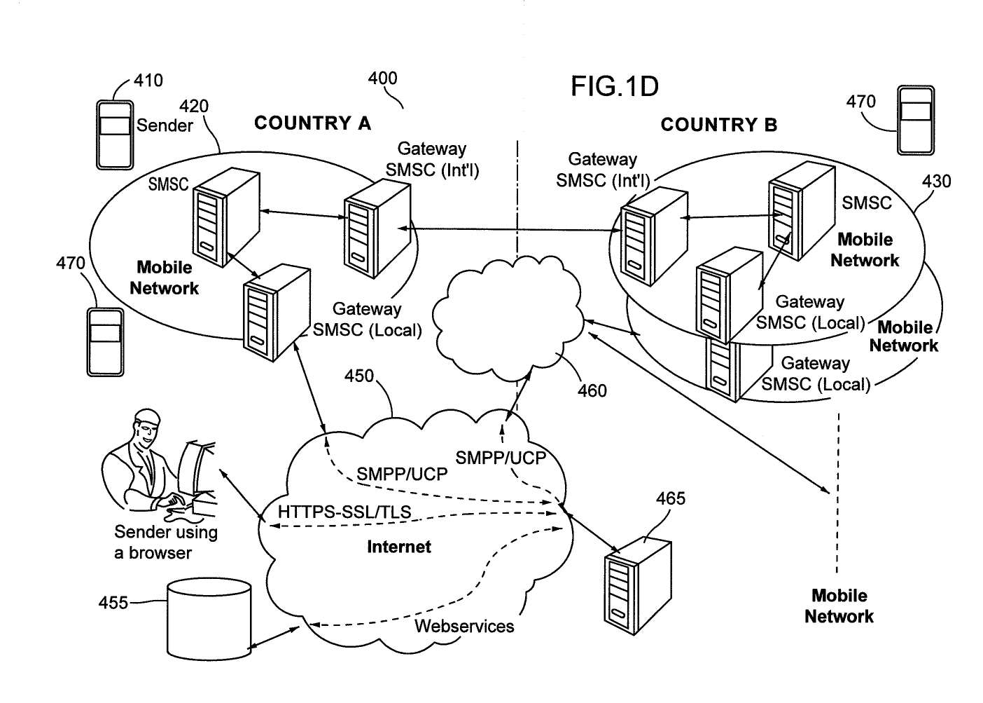

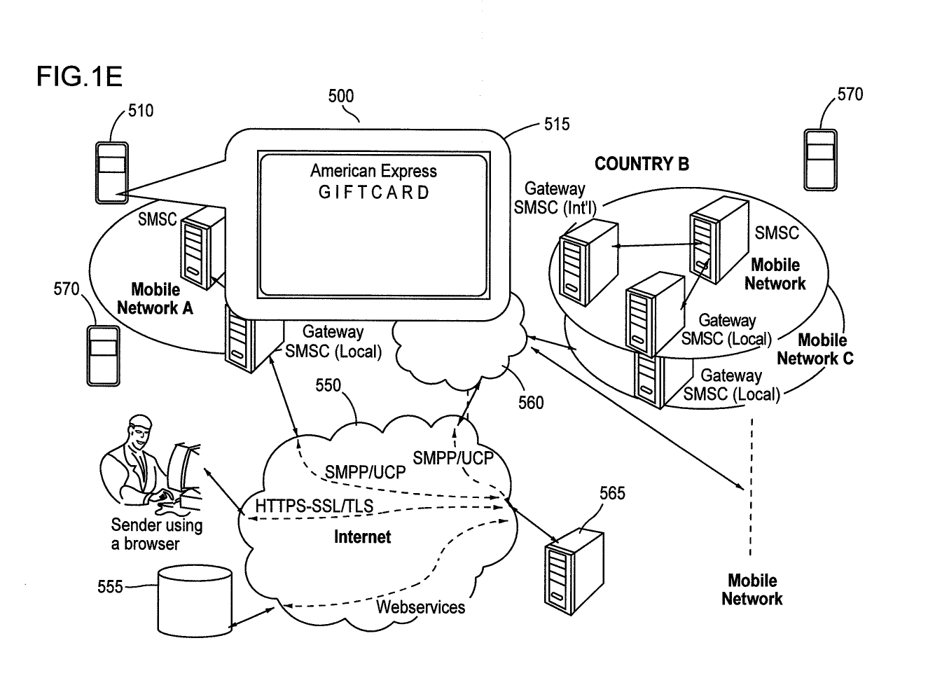

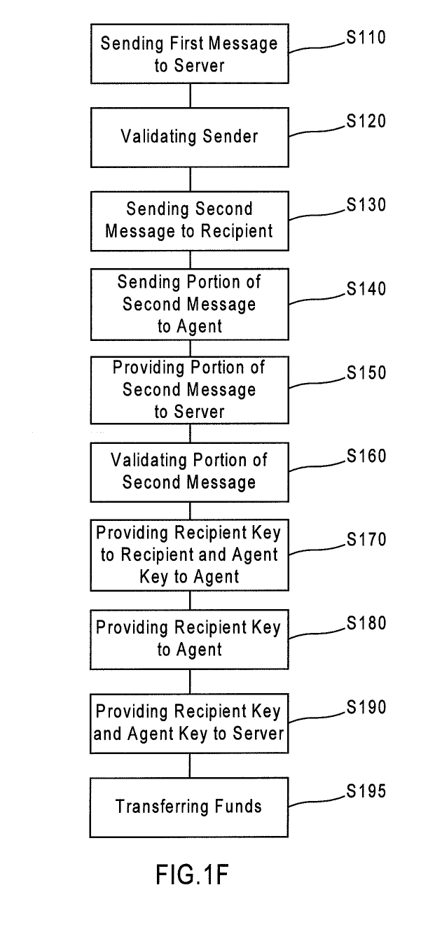

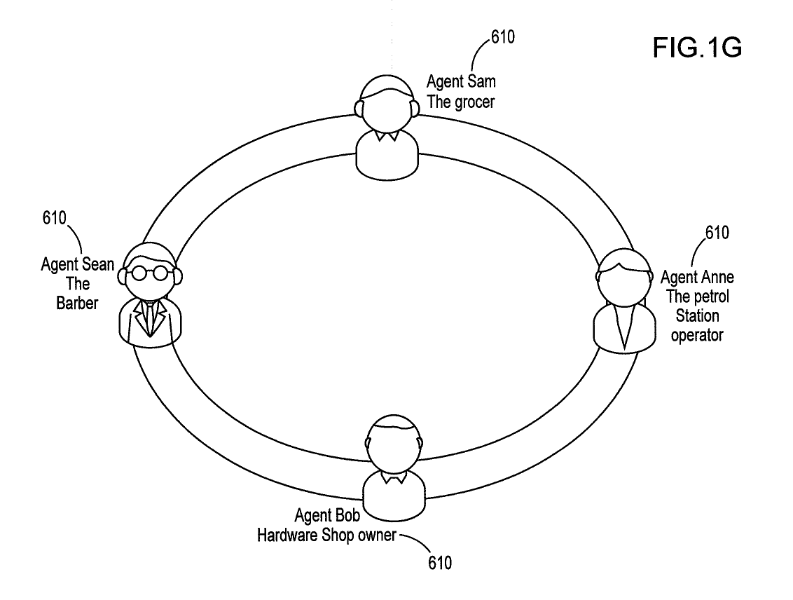

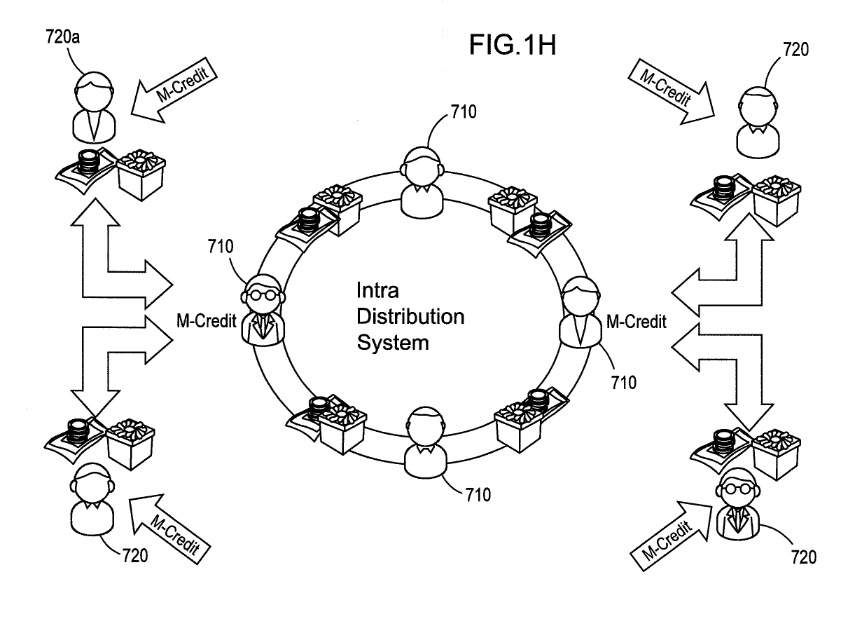

Referring to FIG. 1A, therein shown is a local “on” net mobile SMS remittance system 100, including a mobile network 120 within a given country A, a mobile network 130 within the same country A, a mobile network 140 within a different country B, and a mobile network 150 within country B. FIG. 1A illustrates a remittance t being transferred between a sender 110, who is a subscriber of the mobile network 120, and another subscriber of the same mobile network A, in accordance with aspects of the present invention.

Referring to FIG. 1B, therein shown is a local “off” net mobile SMS remittance system 200, including a mobile network 220 within a given country A, a mobile network 230 within the same country A, a mobile network 240 within a different country B, and a mobile network 250 within country B. FIG. 1B illustrates a remittance t1 between two subscribers of different mobile networks 220 and 230, in accordance with aspects of the present invention.

Referring now to FIG. 1C, therein shown is an international on net mobile SMS remittance system 300, including a mobile network 320 within a given country A, a mobile network 330 within the same country A, a mobile network 340 within a different country B, and a mobile network 350 within country B. FIG. 1C illustrates a remittance t2 between two subscribers' mobile networks 320 and 340 located in two different countries, in accordance with aspects of the present invention.

As can be seen for FIGS. 1A-C, SMS remittance messages, in accordance with aspects of the present invention, may be sent between two subscribers of any two networks, even networks supporting different carriers, as will be explained in more detail below, regardless of whether the networks have funds transfer agreements with each other or not.

In accordance with aspects of the present invention, the sender and recipient of the mobile SMS remittance may or may not have an account with a service provider, such as a remittance facilitation center.

Referring to FIG. 1D, therein shown is an example SMS telephonic transfer system 400 where the sender 410 has an account with the service provider, and the account has a positive value. According to various aspects, the sender 410 may send a SMS message from mobile network 420 in country A, for example, the SMS message including an M-Pin (a mobile pin number, for example), and an M-Credit (mobile credit, the specified amount of the transfer, for example) to a specific short code. It should be appreciated by those of ordinary skill in the art that this may be achieved via a web browser (e.g., via a Hypertext Transfer Protocol Secure (HTTPS) protocol), as an alternative to a mobile SMS message.

The SMS message may be forwarded to the service provider server 465 via, e.g., a Short Message Peer-to-Peer (SMPP) protocol 450 via the SMS hub 460, which may capture the sender's Mobile Subscriber Integrated Services Digital Network (MSISDN) number, may validate the sender via the MSISDN in the prepaid database 455, and may verify the balance in the sender's account. Upon a positive outcome of the validation of the sender and of the verification of the sender's account balance, the service provider server may send a SMS message to the MSISDN of the designated recipient 470, whether a local recipient or a foreign recipient, containing a system-generated serial number and the M-Credit amount. The recipient 470, who may be located in country B, for example, receives the SMS message generated by the service provider server.

An example implementation of a SMS telephonic transfer system 500, where the sender 510 does not have an account with the service provider 565, is described in reference to FIG. 1E. In this example, the SMS telephonic transfer system 500 is described with respect to an American Express® gift card. However, those of ordinary skill in the art will recognize that any other credit card, bank card, gift card or prepaid card may alternatively be used with this implementation. In this implementation, the sender 510 may send an SMS message with the card number an Personal Identification Number (PIN) of the card to a selection of short codes (this may also be achieved via a browser), which may represent various denominations to be transferred. For example, short code 2000 may represent a value of $20, and short code 3000 may represent a value of $30, among other short codes and values. Alternatively, the value of the transfer may be indicated in the SMS message of the sender 510 or otherwise communicated to the service provider's server 565 via, e.g., a Short Message Peer-to-Peer (SMPP) protocol 550 via the SMS hub 560. According to various aspects, the server 565 may store the sender's MSISDN and short code (and/or other indication of amount to be transferred) for billing settlements with the mobile carrier(s) in a database 555. The server may then send an SMS with a system generated serial number and amount to the MSISDN of the recipient 570.

FIG. 1F is a flow chart illustrating a mobile device enabled fund transfer and cash out method, in accordance with aspects of the present invention. According to various aspects, the method starts when a sender sends a remittance message to service provider server at S110, for example in the form of an SMS message sent from the sender's mobile device, as discussed above. The message may include, for example, a mobile pin number and a credit amount corresponding to funds to be transferred to a recipient. When the service provider receives the message from the recipient, the service provider may validate the remittance message at S120, for example by capturing the sender's MSISDN and comparing the sender's MSISDN to a reference database, and by verifying the sender's balance in the sender's account. When the sender has been validated at S120, the service provider may send a message to the recipient that may contain a system-generated serial number and/or gift card or other cash card or credit card number and the amount of funds destined to the recipient in the form of a M-Credit amount at S130.

According to various aspects, once the recipient receives the SMS message with the system-generated serial number and/or gift card or other cash card number and the M-Credit amount at S130, the recipient may approach an authorized agent and provide the system-generated serial number to the authorized agent at S140. According to various aspects, the recipient may provide the agent with only the system-generated serial number. At S150, after receiving the system-generated serial number, the agent may send the system-generated serial number to the service provider's server via SMS or web browser, for example, in order to obtain a funding credit corresponding to the amount of the remittance. Once the server receives the serial number, the server may validate the serial number at S160 to confirm that the agent-provided serial number corresponds to the transaction initiated by the sender. Once the serial number is validated at S160, the server may send a portion of a PIN number, e.g., the first four digits of an 8 digit PIN to the recipient (alternatively referred to herein as the “recipient key”), and the last four digits to the agent (alternatively referred to herein as the “agent key”), in two separate messages, at S170. It should be noted that the 8 digit PIN may actually comprise any number of digits, and any subset of those digits may be sent to the recipient and/or the agent, respectively, at S170. Once the recipient receives the portion of the PIN, the recipient may then provide the received 4 digits to the agent at S180 in order to obtain the remittance. According to various aspects, when the agent receives the recipient key, or recipient portion of the PIN at S180, the agent may then send the complete 8 digit PIN, for example via SMS, to the service provider at S190. As a result, the server may transfer the funds to the agent's Mobile wallet (M-wallet) as a mobile credit or M-Credit, along with a commission, for example, at S195. It should be noted that absent both the recipient key and the agent key, the service provider may not transfer the funds to the agent, and the transaction may not be completed. When the agent receives the fund, the agent may provide the funds directly to the recipient, for example, in the form of cash, and may keep the commission.

In an alternative example cash out method, once the recipient receives the SMS message with the system-generated serial number and/or gift card or other cash card number and the M-Credit amount, the recipient may enter the serial number at an authorized ATM or bank, thus bypassing the agent. The ATM bank may contact the service provider server to validate the serial number and the recipient's MSISDN. Once the verification is complete, the service provider server may provide a one-time PIN number (e.g., 6-digits) to the recipient. Upon entry of the appropriate PIN number, the ATM/bank may then dispense the correct amount to the recipient.

In accordance with some aspects, although the above discussion indicates that the service provider server communicates with the agent, the service provider may also communicate with main distributors (e.g., in-country partners), who in turn communicate with agents and/or recipients, when the agents are international agents and the in-country partners may be in a better position to communicate with the agents. Most or all members in the distribution hierarchy, which may include in-country partners and agents, may have M-wallets (e.g., a virtual pre-paid card), each of which has an initial value of $0. The cash-out amount with commission may be credited to the M-wallet of the agent and to the in-country partner, if applicable, after the transaction is completed. The agents may be paid from the next level up, e.g. the in-country partner of the service provider, or from a lateral fellow-agent. Thus, the M-credits travel up the hierarchy, from the recipients to the service provider, while the funds travel down the hierarchy, from the service provider to the recipients. Payouts or settlements within the hierarch may be scheduled on any agreed-upon basis (e.g., daily, weekly, monthly).

An example payout/settlement in accordance with aspects of the present invention will now be described in reference to FIG. 1G. According to various aspects, if an agent 610 does not wish to wait for the settlement date (e.g., daily, weekly, monthly), the agent 610 may send a request for cash/credit advance out of the agent's M-wallet to a predetermined SMS code (e.g., “R,35” to request a $35 advance) to the service provider. The service provider may generate, based on the SMS message, a serial number and amount, similar to the remittance flow described above, but without participation of a sender (i.e., the requesting agent is the sender and the recipient in this variation). The requesting agent (e.g., the gas station operator) may then approach a fellow agent (e.g., the grocer) for cash out. A similar cash out mechanism as in the remittance process described above may be applicable here, except that the agent may request a part or the entire payment amount in goods and/or services from the other agent, such as, e.g., 2 lbs of rice and the remainder in cash. In this case, the grocer fellow agent may realize a profit margin on the requested 2 lbs of rice in addition, for example, to the commission. The service provider may also receive a fee from the requesting agent for the transaction.

In this manner, the recipients themselves may be motivated to sign up as agents, which may require a database entry of the agent's MSISDN for verification purposes, as their subsequent remittance/payout transactions may be more efficient. The more agents sign up, the more the system may grow, and an ever-expanding mobile commerce ecosystem, as shown in FIG. 1H, may be created. In FIG. 1H, the recipient 720 may receive a mobile remittance from a relative, for example. Recipient 720 may then cash that mobile remittance through an agent 710, and the remittance amount may be transferred to the M-wallet of the agent 710. According to various aspects, the recipient 720 may wish to become an agent 710, thereby decreasing the service provider overhead, as the transfers may now be from the M-wallet of the recipient-become-agent 720 to the M-wallet of another agent 710, for example. Thus, an intra-distribution system may expand.

Agent recruitment, in accordance with aspects of the present invention may be achieved via a potential agent sending a SMS message to a specific short code for agent registration. Upon receipt of the SMS message, the service provider may respond with an SMS containing an Agent ID (AID) and a message to contact the service provider. The service provider may create a new record with the new AID and the agent's MSISDN. To complete the registration, the new agent may contact the service provider to provide more information, although this may not be necessary, in accordance with some aspects, and the agent's record may be updated. Additional information, such as a starter kit including stickers, decal and instruction manual, among other starter kit items, may then be sent to the new agent.

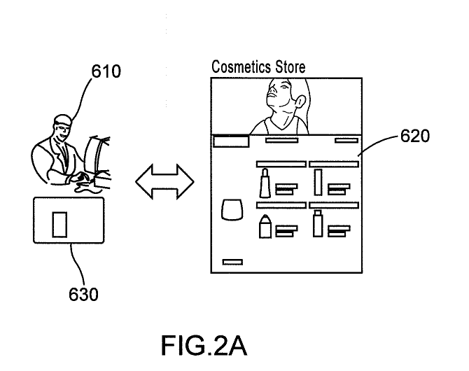

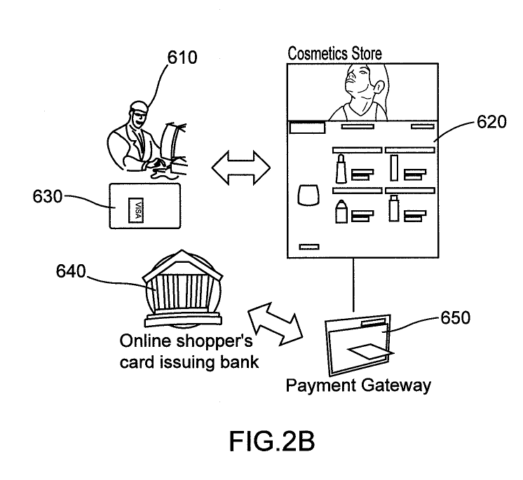

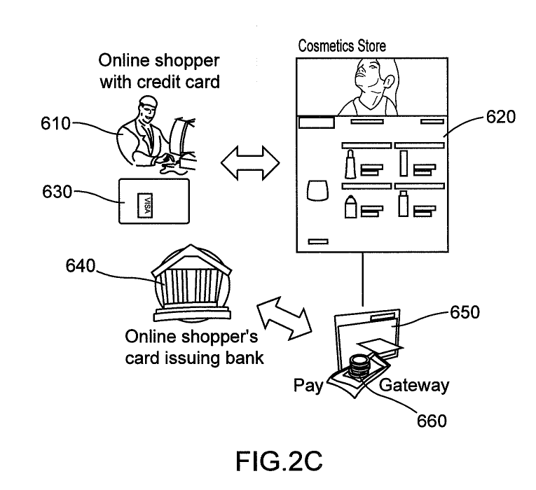

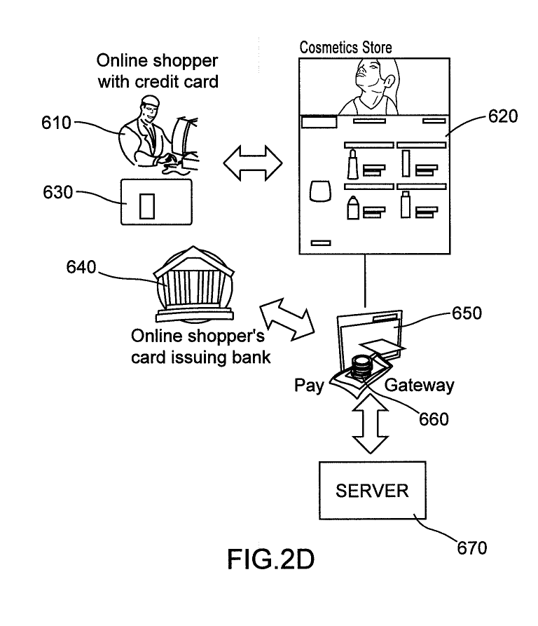

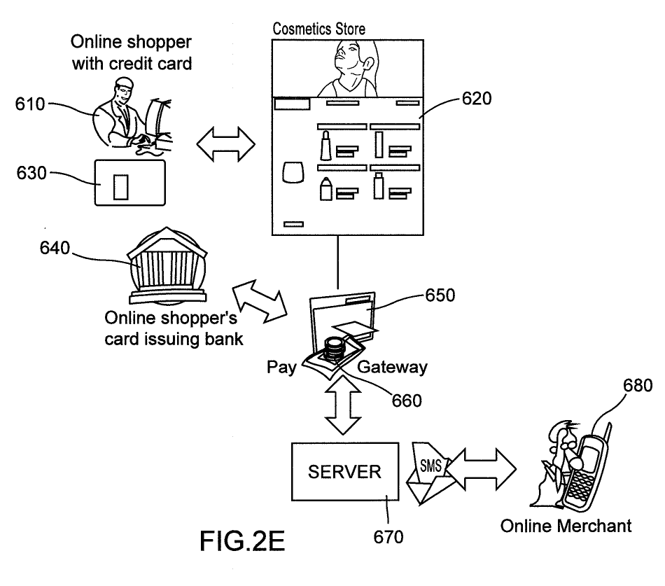

FIGS. 2A-E illustrate various implementations in accordance with aspects of the present invention. In FIG. 2A, a shopper 610 who may be, for example, online via a network such as, e.g., the Internet, may utilize a credit card 630 to place an order at a retailer's website 620. According to various aspects, the retailer may not have the ability to process the credit card 630. Accordingly, FIGS. 2B-C illustrate a transaction involving the credit card 630 and the bank 640 that issued the credit card 630, where the bank 640 communicates with a payment gateway 650 corresponding to aspects of the current invention. As illustrated in FIG. 1C, the payment gateway 650 may communicate with the bank 640 to request payment from the card issuing bank 640, and may keep the payment in a virtual account 660. According to various aspects, and as illustrated in FIG. 2D, the funds provided from the bank 640 and located in the virtual account 660 in the form of virtual funds may then be sent to a server 670 according to various aspects of the current invention, where the server 670 may be similar to the servers 465 and 565 discussed above. Accordingly, when the server 670 receives the virtual funds transferred by the bank 640 via the payment gateway 650, the server 670 may then, as illustrated in FIG. 2E, provide the virtual funds to a device 680 of the merchant, such as, e.g., a mobile device 680 of the merchant, via a mobile transaction as described above. As a result, the merchant may then utilize the device 680 to convert the virtual funds to real funds via, for example, an agent, or an ATM machine, as discussed above with respect to FIG. 1F, even when the merchant may not have the ability to process a credit card, as is sometimes the case in remote and under-developed parts of the world.

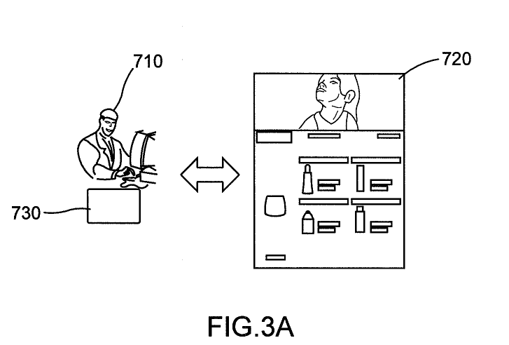

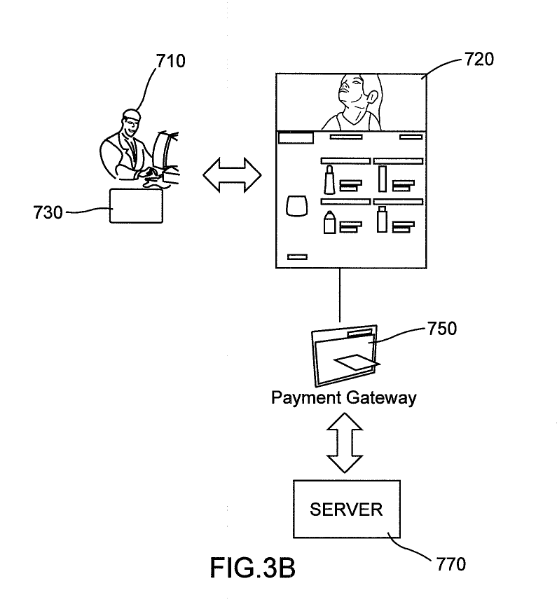

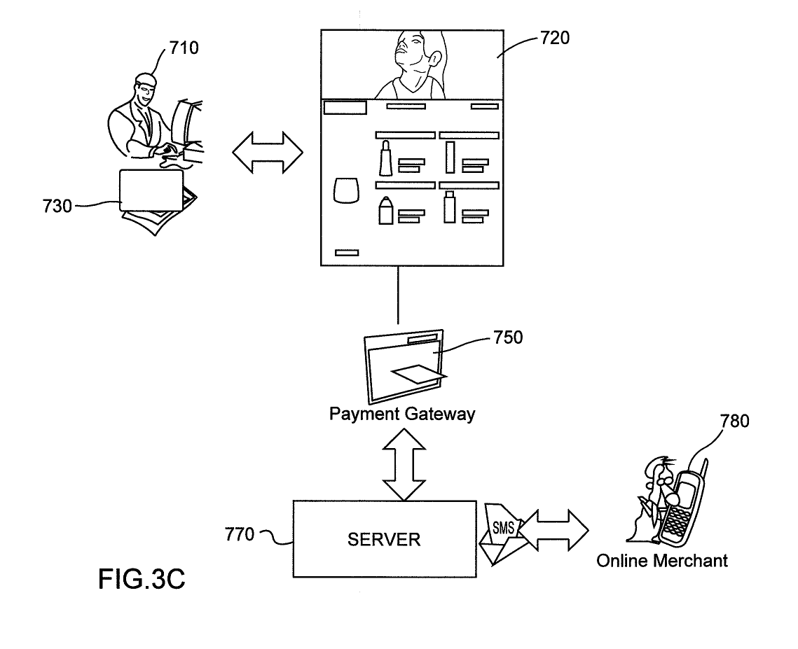

FIGS. 3A-C illustrate various implementations in accordance with aspects of the present invention. In FIG. 3A, a shopper 710 who may be, for example, online via a network such as, e.g., the Internet, may utilize an affiliated prepaid card 730 to place an order at a retailer's website 720. According to various aspects, the affiliated pre-paid card 730 may be card funded via a server according to various aspects of the current invention, where the funds have been verified, and the identity of the shopper 710 using the pre-paid card 730 has been validated, by the server. As such, funds from the prepaid card 730 may be transferred to the payment gateway 750, which may keep the payment in a virtual account. According to various aspects, and as illustrated in FIG. 3B, the funds provided from the pre-paid card 730 and located in the virtual account in the form of virtual funds may then be sent to a server 770 according to various aspects of the current invention, where the server 770 may be similar to the servers 465 and 565 discussed above. Accordingly, when the server 770 receives the virtual funds transferred by the prepaid card 730 via the payment gateway 750, the server 770 may then, as illustrated in FIG. 3C, provide the virtual funds to a device 780 of the merchant, such as, e.g., a mobile device 780 of the merchant, via a mobile transaction. As a result, the merchant may then utilize the device 780 to convert the virtual funds to real funds via, for example, an agent, or an ATM machine, as discussed above with respect to FIG. 1F.

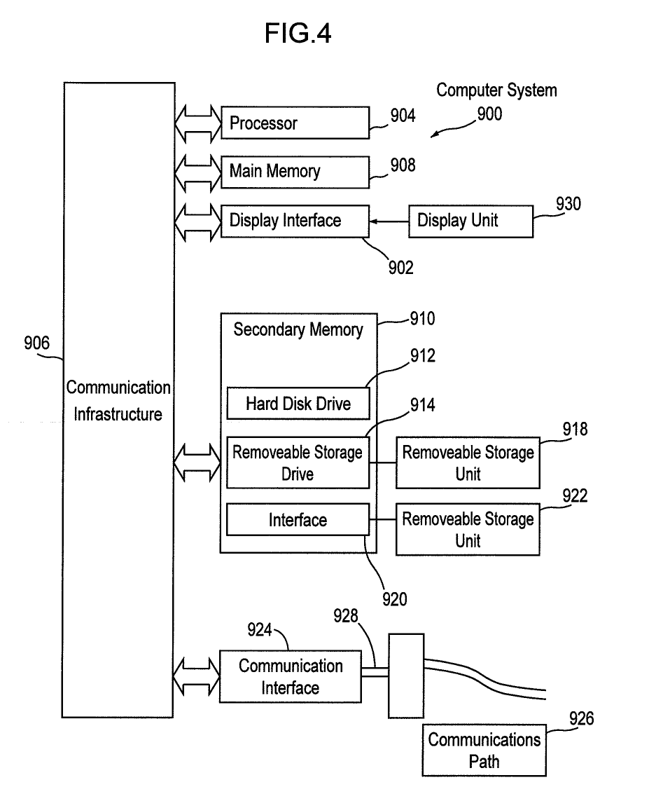

In some variations, aspects of the present invention may be directed toward one or more computer systems capable of carrying out the functionality described herein. An example of such a computer system 200 is shown in FIG. 4.

Computer system 200 includes one or more processors, such as processor 204. The processor 204 is connected to a communication infrastructure 206 (e.g., a communications bus, cross-over bar, or network). Various software aspects are described in terms of this example computer system. After reading this description, it will become apparent to a person skilled in the relevant art(s) how to implement the invention using other computer systems and/or architectures.

Computer system 200 can include a display interface 202 that forwards graphics, text, and other data from the communication infrastructure 206 (or from a frame buffer not shown) for display on a display unit 230. Computer system 200 also includes a main memory 208, preferably random access memory (RAM), and may also include a secondary memory 210. The secondary memory 210 may include, for example, a hard disk drive 212 and/or a removable storage drive 214, representing a floppy disk drive, a magnetic tape drive, an optical disk drive, etc. The removable storage drive 214 reads from and/or writes to a removable storage unit 218 in a well-known manner. Removable storage unit 218, represents a floppy disk, magnetic tape, optical disk, etc., which is read by and written to removable storage drive 214. As will be appreciated, the removable storage unit 218 includes a computer usable storage medium having stored therein computer software and/or data.

In alternative aspects, secondary memory 210 may include other similar devices for allowing computer programs or other instructions to be loaded into computer system 200. Such devices may include, for example, a removable storage unit 222 and an interface 220. Examples of such may include a program cartridge and cartridge interface (such as that found in video game devices), a removable memory chip (such as an erasable programmable read only memory (EPROM), or programmable read only memory (PROM)) and associated socket, and other removable storage units 222 and interfaces 220, which allow software and data to be transferred from the removable storage unit 222 to computer system 200.

Computer system 200 may also include a communications interface 224. Communications interface 224 allows software and data to be transferred between computer system 200 and external devices. Examples of communications interface 224 may include a modem, a network interface (such as an Ethernet card), a communications port, a Personal Computer Memory Card International Association (PCMCIA) slot and card, etc. Software and data transferred via communications interface 224 are in the form of signals 228, which may be electronic, electromagnetic, optical or other signals capable of being received by communications interface 224. These signals 228 are provided to communications interface 224 via a communications path (e.g., channel) 226. This path 226 carries signals 228 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 214, a hard disk installed in hard disk drive 212, and signals 228. These computer program products provide software to the computer system 200. The invention is directed to such computer program products.

Computer programs (also referred to as computer control logic) are stored in main memory 208 and/or secondary memory 210. Computer programs may also be received via communications interface 224. Such computer programs, when executed, enable the computer system 200 to perform the features of the present invention, as discussed herein. In particular, the computer programs, when executed, enable the processor 210 to perform the features of the present invention. Accordingly, such computer programs represent controllers of the computer system 200.

In an aspect where the invention is implemented using software, the software may be stored in a computer program product and loaded into computer system 200 using removable storage drive 214, hard drive 212, or communications interface 220. The control logic (software), when executed by the processor 204, causes the processor 204 to perform the functions of the invention as described herein. In another aspect, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another aspect, the invention is implemented using a combination of both hardware and software.

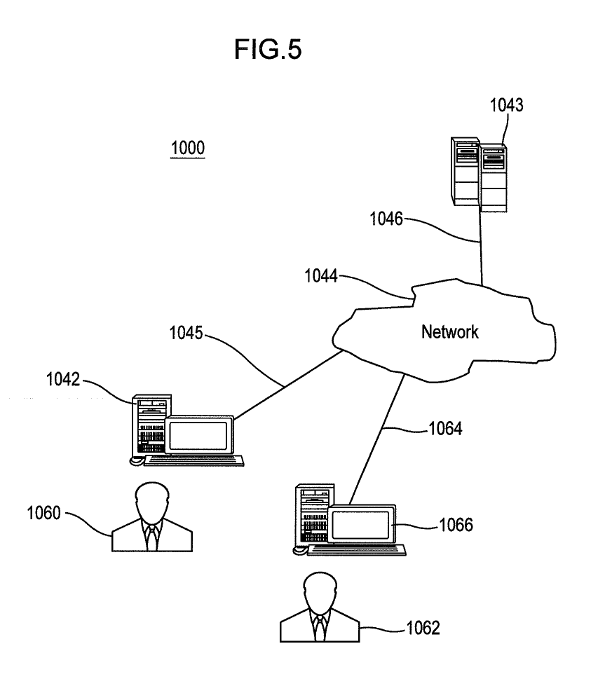

FIG. 5 shows a communication system 300 involving use of various features in accordance with aspects of the present invention. The communication system 300 includes one or more assessors 360, 362 (also referred to interchangeably herein as one or more “users”) and one or more terminals 342, 366 accessible by the one or more accessors 360, 362. In one aspect, operations in accordance with aspects of the present invention is, for example, input and/or accessed by an accessor 360 via terminal 342, such as personal computers (PCs), minicomputers, mainframe computers, microcomputers, telephonic devices, or wireless devices, such as personal digital assistants (“PDAs”) or a hand-held wireless devices coupled to a remote device 343, such as a server, PC, minicomputer, mainframe computer, microcomputer, or other device having a processor and a repository for data and/or connection to a repository for data, via, for example, a network 344, such as the Internet or an intranet, and couplings 345, 364. The couplings 345, 364 include, for example, wired, wireless, or fiberoptic links. In another aspect, the method and system of the present invention operate in a stand-alone environment, such as on a single terminal.

While this invention has been described in conjunction with the example aspects outlined above 9and further described in Attachment A), various alternatives, modifications, variations, improvements, and/or substantial equivalents, whether known or that are or may be presently unforeseen, may become apparent to those having at least ordinary skill in the art. Accordingly, the example aspects of the invention, as set forth above, are intended to be illustrative, not limiting. Various changes may be made without departing from the spirit and scope of the invention. Therefore, the invention is intended to embrace all known or later-developed alternatives, modifications, variations, improvements, and/or substantial equivalents.

What is claimed is:

1. A method of transferring funds between mobile devices, comprising:
sending a first message to a server, the first message including a mobile pin number and a mobile credit amount, from a sender's mobile device;
validating the sender via the server;
sending a second message from the server to a recipient's mobile device; and
transferring funds to the recipient based on the first message and the second message.

2. The method of claim 1, wherein validating the sender comprises capturing the sender's identity and verifying the sender's fund balance.

3. The method of claim 1, wherein transferring the funds to the recipient is performed via an agent.

4. The method of claim 1, wherein the server comprises a service provider for one of the mobile devices.

5. The method of claim 4, wherein the server is not a service provider to another of the mobile devices.

6. The method of claim 1, wherein the first message comprises at least one of a bank card number, a gift card number, and a pre-paid card number.

7. The method of claim 1, wherein the second message comprises at least one of a serial number, a gift card number, a cash card number, and a credit card number.

8. The method of claim 1, wherein transferring funds to the recipient based on the first message and the second message comprises:
sending a portion of the second message from the recipient to an agent;
providing the portion of the second message to the server from the agent;
validating the portion of the second message;
providing a recipient key to the recipient on the recipient's mobile device and an agent key to the agent from the server;
providing the recipient key from the recipient to the agent;
providing recipient key and agent key to the server; and
transferring funds to a mobile wallet of the agent in response to receipt of the recipient key and the agent key.

9. The method of claim 8, further comprising providing the funds from the agent to the recipient.

10. The method of claim 8, wherein the portion of the second message comprises the serial number.

11. The method of claim 8, wherein transferring funds to a mobile wallet of the agent comprises transferring a commission to the agent.

12. A method of ensuring online payment to a retailer, comprising:
receiving bank card information including funds from a customer;
transferring funds from a bank issuing the bank card to a virtual account;
receiving virtual funds from the virtual account; and
transferring the funds to a mobile wallet of the retailer.

13. The method of claim 12, wherein the virtual account is located at a payment gateway.

14. A method of ensuring online payment to a retailer, comprising:
receiving information about an approved pre-paid card including funds from a customer;
transferring funds from the approved pre-paid card to a virtual account;
receiving virtual funds from the virtual account; and
transferring the funds to a mobile wallet of the retailer.

15. A system for transferring funds between mobile devices, the system comprising:
means for sending a first message to a server, the first message including a mobile pin number and a mobile credit amount, from a sender's mobile device;
means for validating the sender via the server; and
means for sending a second message from the server to a recipient's mobile device; and
means for transferring funds to the recipient based on the first message and the second message.

16. A system for transferring funds between mobile devices, the system comprising:
a processor;
a user interface functioning via the processor; and
a repository accessible by the processor; wherein
a first message is sent to a server, the first message including a mobile pin number and a mobile credit amount, from a sender's mobile device;
the sender is validated via the server;
a second message is sent to a recipient from the server; and
funds are transferred to the recipient based on the first message and the second message.

17. A computer program product comprising a computer usable medium having control logic stored therein for causing a computer to exchange user-generated community information, the control logic comprising:
first computer readable program code means for sending a first message to a server, the first message including a mobile pin number and a mobile credit amount, from a sender's mobile device;
second computer readable program code means for validating the sender via the server;
third computer readable program code means for sending a second message from the server to a recipient's mobile device; and
fourth computer readable program code means for transferring funds to the recipient based on the first message and the second message.

18. A system for ensuring online payment to a retailer, comprising:
means for receiving bank card information including funds from a customer;
means for transferring funds from a bank issuing the bank card to a virtual account;
means for receiving virtual funds from the virtual account; and
means for transferring the funds to a mobile wallet of the retailer.

19. A system for ensuring online payment to a retailer, comprising:
means for receiving information about an approved pre-paid card including funds from a customer;
means for transferring funds from the approved pre-paid card to a virtual account;
means for receiving virtual funds from the virtual account; and
means for transferring the funds to a mobile wallet of the retailer.

20. The system of claim 16, wherein the processor is housed on a terminal
selected from a group consisting of a personal computer, a minicomputer, a main frame computer, a microcomputer, a hand held device, and a telephonic device.

21. The system of claim 16, wherein the processor is housed on a server selected from a group consisting of a personal computer, a minicomputer, a microcomputer, and a main frame computer.

22. The system of claim 21, wherein the server is coupled to a network that comprises the Internet.
